(19) United States
(12) Patent Application Publication
(10) Pub. No.: US 2008/0030647 A1
(43) Pub. Date: Feb. 7, 2008

(54) Liquid Crystal Display Device and Cellular Phone Provided with the Same

(75) Inventors: Toshio Watanabe, Kyoto (JP); Yasushi Kasajima, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: Rohm Co., LTD., Kyoto-shi (JP)

(21) Appl. No.: 11/629,837

(22) PCT Filed: Jun. 22, 2005
(86) PCT No.: PCT/JP05/11428

§ 371 Date: Dec. 15, 2006

(30) Foreign Application Priority Data
Jun. 22, 2004 (JP) 2004-183485

(51) Int. Cl. G02F 1/13357

(52) U.S. Cl. 349/63

(57) ABSTRACT

A liquid crystal display device (B1) according to the present invention includes a first liquid crystal display panel (20A) forming a first display surface (14A), a second liquid crystal display panel (20B) forming a second display surface (14B) which is oriented in an opposite direction from the first display surface (14A), and a light guide plate (30) including a light emitting portion (31) sandwiched between the first and the second liquid crystal display panels (20A), (20B) and a light incident portion (32) provided continuously with the light emitting portion (31) and serving to introduce external light (L) into the light emitting portion (31). The first liquid crystal display panel (20A) is illuminated with external light (L) passed through the second display panel (20B) and the light emitting portion (31) of the light guide plate (30). The second liquid crystal display panel (20B) is illuminated with external light (L) impinged on the light incident surface (32a) of the light guide plate (30) and guided to the second liquid crystal display panel (20B) by the light emitting portion (31).

### TECHNICAL FIELD

The present invention relates to a liquid crystal display device and a cellular phone provided with such a liquid crystal display device.

### BACKGROUND ART

Cellular phones with high function are increasingly developed year by year. As an example of such a cellular phone with high function, a cellular phone is widely used which includes a main body, and a lid pivotally connected to the main body. The lid includes two display surfaces respectively formed on the inner surface and the outer surface thereof. FIG. 6 shows an example of liquid crystal display device used for the so-called flip phone. The liquid crystal display device X includes a first and a second liquid crystal display panels 91A and 91B so that the displaying on opposite sides is possible. As means for illuminating the first and the second liquid crystal display panels 91A and 91B, the liquid crystal display device includes two light emitting elements 92A and 92B, and a first and a second light guide plates 93A and 93B for guiding the light emitted from the light emitting elements 92A and 92B to the first and the second liquid crystal display panels 91A and 91B.

However, to reduce the thickness of the cellular phone and improve the design, the thickness reduction of the liquid crystal display device X is strongly demanded. Further, to increase the continuous driving time of a cellular phone, power saving is demanded. Since the liquid crystal display device X includes two light guide plates 93A and 93B, the thickness reduction is difficult. Further, much power is consumed due to the provision of the two light emitting elements 92A and 92B. Therefore, with respect to the liquid crystal display device X, there is room for improvement as to the thickness reduction and power saving.

Patent Document 1: JP-A-2002-244133 (FIG. 1)

### DISCLOSURE OF THE INVENTION

An object of the present invention, which is conceived under the above-described circumstances, is to provide a liquid crystal display device which is capable of being reduced in thickness and saving power, and to provide a cellular phone provided with such a liquid crystal display device.

To achieve the above-described object, the present invention takes the following technical measures.

According to a first aspect of the present invention, there is provided a liquid crystal display device comprising a first liquid crystal display panel forming a first display surface, a second liquid crystal display panel forming a second display surface which is oriented in an opposite direction from the first display surface, and a light guide member including a light emitting portion sandwiched between the first and the second liquid crystal display panels and a light incident portion provided continuously with the light emitting portion and serving to introduce external light into the light emitting portion. The first liquid crystal display panel is illuminated with external light passed through the second display panel and the light emitting portion of the light guide member. The second liquid crystal display panel is illuminated with external light impinged on the light incident portion of the light guide member and guided to the second liquid crystal display panel by the light emitting portion.

In a preferred embodiment of the present invention, the light emitting portion is in the form of a plate.

In a preferred embodiment of the present invention, the light guide member includes a reflective surface for reflecting light entering through the light incident portion toward the light emitting portion.

In a preferred embodiment of the present invention, the light incident surface is exposed in the same direction as the second display surface.

In a preferred embodiment of the present invention, the light incident surface is in the form of a strip and arranged along an edge of the second display surface.

In a preferred embodiment of the present invention, a plurality of light incident surfaces are provided, and the plurality of light incident surfaces are arranged to sandwich the second display surface.

In a preferred embodiment of the present invention, each of the first and the second liquid crystal display panels is provided with a pair of polarizers whose polarization directions extend perpendicular to each other. The polarization direction of one of the paired polarizers of the first liquid crystal display panel which is provided on the side of the second liquid crystal display panel corresponds to the polarization direction of one of the paired polarizers of the second liquid crystal display panel which is provided on the side of the first liquid crystal display panel.

According to a second aspect of the present invention, there is provided a cellular phone comprising a main body, and a lid pivotally connected to the main body via a hinge portion. The liquid crystal display device according to the first aspect of the present invention is mounted to the lid, and the first and the second display surfaces are provided on an inner surface and an outer surface of the lid, respectively.

In the liquid crystal display device according to the present invention, the first and the second liquid crystal display panels can be illuminated with external light, so that e.g. a light emitting element for illuminating the liquid crystal display panels does not need to be provided. Therefore, power can be saved by as much as the amount consumed for the light emission by the light emitting element. Further, as the light guide member, it is possible to use only one light guide member for illuminating the second liquid crystal display, so that the structure of the liquid crystal display device can be simplified.

With the cellular phone according to the present invention, reduction in thickness of the lid and power saving are possible. Therefore, the cellular phone is advantageous for improving the design and increasing the continuous driving time. When the first display surface is to be visually recognized in using the cellular phone in the open state, the first liquid crystal display panel is illuminated by transmitting the light impinging on the second display surface. Therefore, the first display surface can be seen with high visibility, and the operation of the mobile phone can be performed properly. On the other hand, when the second display surface is to be visually recognized in using the cellular phone in the closed state, external light is introduced through the light incident surface of the light guide member, and the second liquid crystal display panel is illuminated with the light. In this way, the first and the second display surfaces with appropriate visibility can be provided while reducing the thickness and saving the power.

### BRIEF DESCRIPTION OF THE DRAWINGS

FIG. 1 is an overall perspective view showing an example of cellular phone according to the present invention.

FIG. 2 is an overall perspective view showing an example of cellular phone according to the present invention.

FIG. 3 is a sectional view taken along lines III-III in FIG. 1 for showing a principal portion.

FIG. 4 is a sectional view taken along lines IV-IV in FIG. 2 for showing a principal portion.

FIG. 5 is a sectional view showing a principal portion of another example of cellular phone and liquid crystal display device according to the present invention.

FIG. 6 is a sectional view showing an example of conventional liquid crystal display device.

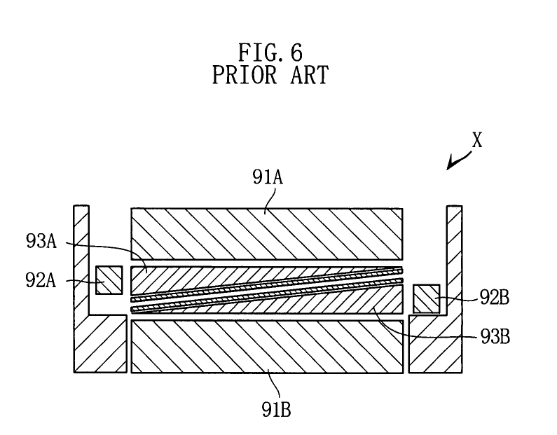

### BEST MODE FOR CARRYING OUT THE INVENTION

Preferred embodiments of the present invention will be described below in detail with reference to the accompanying drawings.

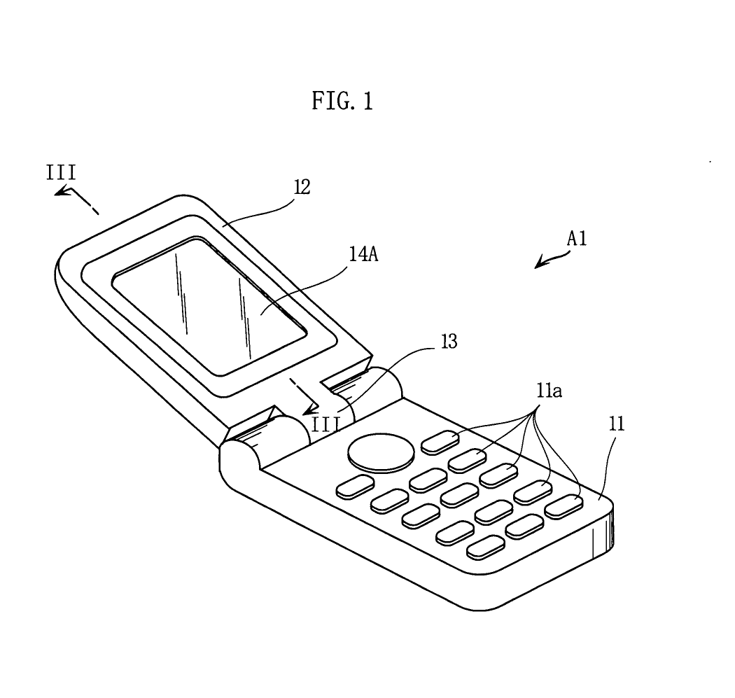

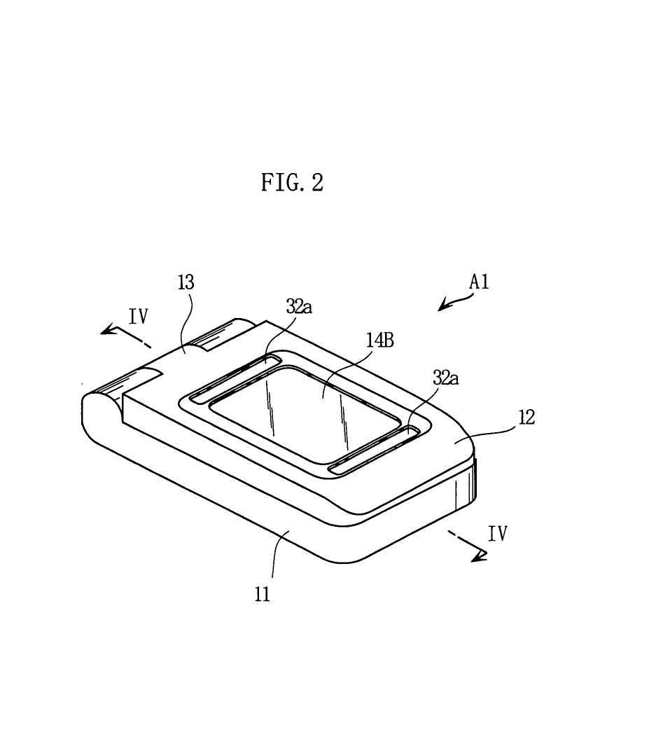

FIGS. 1 and 2 show an example of cellular phone according to the present invention. As better shown in FIG. 1, the cellular phone A1 includes a main body 11 and a lid 12 and is structured as the so-called flip phone.

The main body 11 has an obverse surface provided with a plurality of operation buttons 11a and a reverse surface provided with e.g. a rechargeable battery (not shown).

The lid 12 is pivotally connected to the main body 11 via a hinge portion 13. By opening and closing the lid 12, the cellular phone A1 can be used in the open state or the closed state. The surface of the lid 12 (hereinafter referred to as “inner surface”) which faces the obverse surface of the main body 11 in the closed state is provided with a first display surface 14A. The first display surface 14A displays information necessary for the operations such as calling or sending and receiving mails, for example.

As better shown in FIG. 2, the surface of the lid 12 (hereinafter referred to as “outer surface”) which is opposite from the inner surface is provided with a second display surface 14B. The second display surface 14B is mainly seen when the cellular phone A1 is in the closed state and displays information about incoming call or receiving of mail, or the content of received mail, for example.

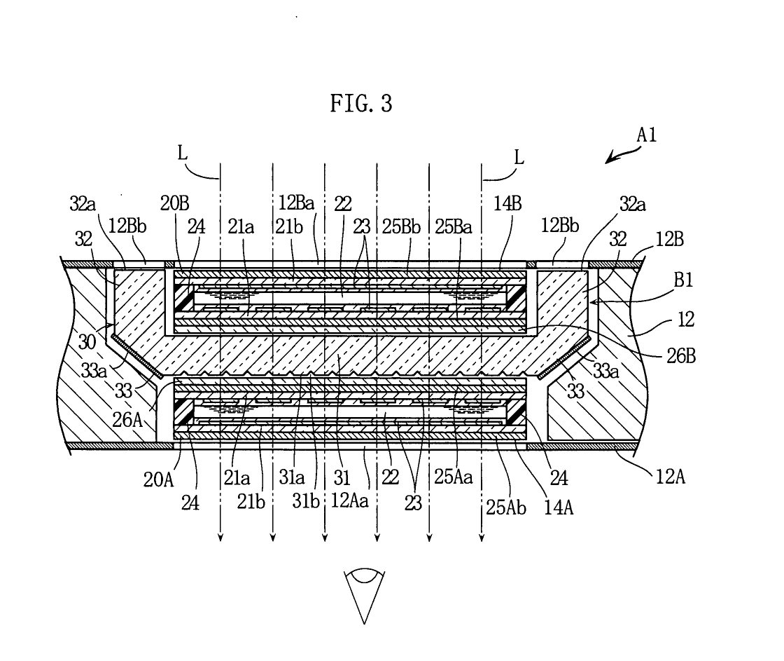

As shown in FIG. 3, a liquid crystal display device B1 as an example of liquid crystal display device according to the present invention is mounted to the lid 12. FIG. 3 is a sectional view showing a principal portion of the liquid crystal display device B1 mounted to the lid 12. In this figure, the lower surface is the inner surface, whereas the upper surface is the outer surface.

The liquid crystal display device B1 includes a first and a second liquid crystal display panels 20A and 20B, and a light guide plate 30. The first liquid crystal display panel 20A provides the first display surface 14A, whereas the second liquid crystal display panel 20B provides the second display surface 14B. The first liquid crystal display panel 20A is disposed in the liquid crystal display device B1 at a portion adjacent to the inner surface (lower side in FIG. 3) of the lid 12. The lid 12 includes a decorative panel 12A formed with a window 12Aa for exposing the first display surface 14A. The first liquid crystal display panel 20A includes a pair of transparent substrates 21a and 21b, a liquid crystal layer 22, and a pair of polarizers 25Aa and 25Ab.

The paired transparent substrates 21a and 21b are made of glass. A plurality of electrodes 23 are formed at a surface of the transparent substrate 21a and a surface of the transparent substrate 21b which face each other. The electrodes 23 are transparent electrodes and electrically connected to e.g. an IC chip (not shown). The liquid crystal layer 22 is provided in a region which is defined between the transparent substrates 21a and 21b and which is hermetically sealed by a sealing portion 24 surrounding the region. The liquid crystal layer 22 is formed by loading liquid crystal material into the sealed region.

The paired polarizers 25Aa and 25Ab are so provided as to sandwich the paired transparent substrates 21a and 21b. Specifically, the polarizer 25Aa is provided on the outer surface of the transparent substrate 21a, whereas the polarizer 25Ab is provided on the outer surface of the transparent substrate 21b. The polarizer 25Aa and the polarizer 25Ab are so arranged that the respective polarization directions extend perpendicular to each other.

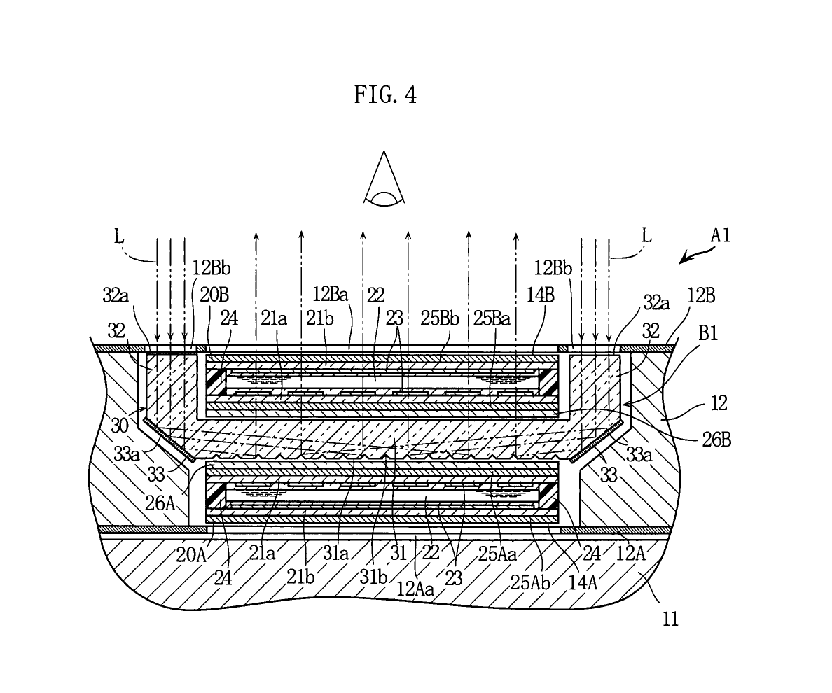

A prism sheet 26A is provided in the first liquid crystal display panel 20A at a portion which is most close to the light guide plate 30. Specifically, the prism sheet 26A is provided on the polarizer 25Aa so as to face the light guide plate 30. The prism sheet 26A has a surface with fine irregularities (not shown in FIGS. 3 and 4) and refracts the light traveling through the light guide plate 30 at the irregular surface to increase the directivity of the light and enhance the illumination brightness of the first liquid crystal display panel 20A. As the prism sheet 26A, use may be made of BEF sheet (registered trademark) available from Sumitomo 3M.

The second liquid crystal display panel 20B is disposed in the liquid crystal display device B1 at a portion adjacent to the outer surface (upper side in FIG. 3) of the lid 12. Similarly to the first liquid crystal display panel 20A, the second liquid crystal display panel 20B includes a pair of transparent substrates 21a and 21b, a liquid crystal layer 22, and a pair of polarizers 25Ba and 25Bb.

The polarizer 25Ba and the polarizer 25Bb are so arranged that the respective polarization directions extend perpendicular to each other. Further, the polarizer 25Ba which is disposed on the side of the light guide plate 30 is so arranged that the polarization direction thereof corresponds to that of the polarizer 25Aa of the first liquid crystal display panel 20A which is disposed on the side of the light guide plate 30.

The prism sheet 26B serves to enhance the illumination brightness of the second liquid crystal display panel 20B, and use may be made of one similar to the prism sheet 26A.

The light guide plate 30 serves to illuminate the second liquid crystal display panel 20B. The light guide plate 30 includes a light emitting portion 31 which is in the form of a plate, two light incident portions 32, and two reflective surfaces 33. The light guide plate 30 is made of a transparent material such as acrylic resin, for example.

The light emitting portion 31 is in the form of a rectangular plate and sandwiched between the first and the second liquid crystal display panels 20A and 20B. The light emitting portion 31 has an inner surface 31a formed with a plurality of angular grooves 31b. Of the inner surface 31a, the region between adjacent grooves 31b is a smooth surface extending generally in parallel with the first and the second display surfaces 14A and 14B.

The two light incident portions 32 are formed by extending opposite ends of the light emitting portion 31 toward the outer surface of the lid 12 so that the light incident portions extend perpendicular to the light emitting portion 31. Respective end surfaces of the two light incident portions 32 are generally flush with the second display surface 14B and provides light incident surfaces 32a each in the form of a strip (See FIG. 2). As shown in FIG. 2, the light incident surfaces 32a are exposed at the outer surface of the lid 12 and arranged to flank the second display surface 14B. Specifically, the two light incident surfaces 32a extend along opposite end edges of the second display surfaces 14B. The lid 12 further includes a decorative panel 12B formed with windows 12Ba and 12Bb for exposing the second display surface 14B and two light incident surfaces 32a, respectively.

The two reflective surfaces 33 serve to reflect the light entering through the light incident surfaces 32a toward the light emitting portion 31. As shown in FIG. 3, since the light emitting portion 31 extends in parallel with the outer and the inner surfaces of the lid 12, the two reflective surfaces 33 are inclined at 45 degrees to the light incident surfaces 32a. Each of the light reflective surfaces 33 is formed with a reflection film 33a for improving directivity of the reflected light. For the reflection film 33a, use may be made of an aluminum film subjected to a hairline finish.

The operation and advantages of the cellular phone A1 will be described below.

When the cellular phone is used with the lid 12 opened as shown in FIGS. 1 and 3, the first display surface 14A is visually recognized. As better shown in FIG. 3, in the first liquid crystal display panel 20A, based on the pixel data constituting the image to be displayed at the first display surface 14A, a predetermined voltage is applied to the electrodes 23 corresponding to the pixels, and the polarization direction of each pixel of the liquid crystal layer 22 is determined. On the other hand, in the second liquid crystal display panel 20B, the liquid crystal layer 22 is kept in the white display state, i.e., in the state in which all the pixels of the liquid crystal layer 22 can transmit white light.

When the user holds the lid 12 in the direction in which external light L is coming, the external light L impinges on the second display surface 14B and travels through the second liquid crystal display panel 20B which is in the white display state. The light traveled through the second liquid crystal display panel 20B then travels through the light guide plate 30. As noted before, the polarization direction of the polarizer 25Ba of the second liquid crystal display panel 20B corresponds to the polarization direction of the polarizer 25Aa of the first liquid crystal display panel 20A. Therefore, the light traveled through the second liquid crystal display panel 20B can enter the first liquid crystal display panel 20A without being blocked by the polarizer 25Aa. The light then travels through the liquid crystal layer 22 of the first liquid crystal display panel 20A and is emitted from the first display surface 14A. As a result, the user of the cellular phone A1 can visually recognize the image or characters displayed at the first display surface 14A and operate the cellular phone A1 or read the received mail, for example.

When the cellular phone is used with the lid 12 closed as shown in FIGS. 2 and 4, the second display surface 14B is visually recognized.

As better shown in FIG. 4, in the second liquid crystal display panel 20B, based on the pixel data constituting the image to be displayed at the second display surface 14B, a predetermined voltage is applied to the electrodes 23 corresponding to the pixels, and the polarization direction of each pixel of the liquid crystal layer 22 is determined. On the other hand, in the first liquid crystal display panel 20A, the liquid crystal layer 22 is kept in the black display state, i.e., in the state in which white light cannot travel through the liquid crystal layer 22.

In this state, part of the external light traveled toward the lid 12 impinges on the two light incident surfaces 32a. The light thus entered through the light incident surfaces 32a is then reflected at the reflective surface 33 toward the light emitting portion 31. The light reaching the inner surface 31a of the light emitting portion 31 is reflected upward by the grooves 31b and emitted from the light emitting portion 31. The light emitted from the light emitting portion 31 enters the second liquid crystal display panel 20B, passes through the liquid crystal layer 22 and is then emitted from the second display surface 14B. As a result, the user of the cellular phone A1 can visually recognize the image or characters displayed at the second display surface 14B and obtain information about incoming call or received mail, for example.

In this way, according to this embodiment, an image can be properly displayed without providing a light source such as an LED for illuminating the first and the second liquid crystal display panels 20A and 20B constituting the first and the second display surfaces 14A and 14B. Therefore, as compared with a conventional cellular phone, the power consumption of the cellular phone A1 is small, so that the continuous driving time can be increased.

Further, in this embodiment, a single light guide plate 30 is provided between the first liquid crystal display panel 20A and the second liquid crystal display panel 20B, and the first liquid crystal display panel 20A and the second liquid crystal display panel 20B are illuminated by guiding external light by utilizing the light guide plate 30. Therefore, as compared with the conventional structure which includes two light guide plates for illuminating the first and the second display surfaces, respectively, the thickness of the liquid crystal display device B1 can be made small, which leads to the thickness reduction of the lid 12 and the resulting thickness reduction of the cellular phone A1.

When the first display surface 14A is to be visually recognized, the second liquid crystal display panel 20B is in the white display state. Therefore, the external light L impinging on the second display surface 14B is not attenuated in passing through the second liquid crystal display panel 20B, which is advantageous for enhancing the visibility of the first display surface 14A.

On the other hand, when the second display surface 14B is to be visually recognized, the first liquid crystal display surface 20A is in the black display state. Therefore, even when the light entered the light guide plate 30 is emitted toward the first liquid crystal display panel 20A, the light is prevented from leaking toward the main body 1 by passing through the first liquid crystal display panel 20A, which is advantageous for enhancing the visibility of the second display surface 14B.

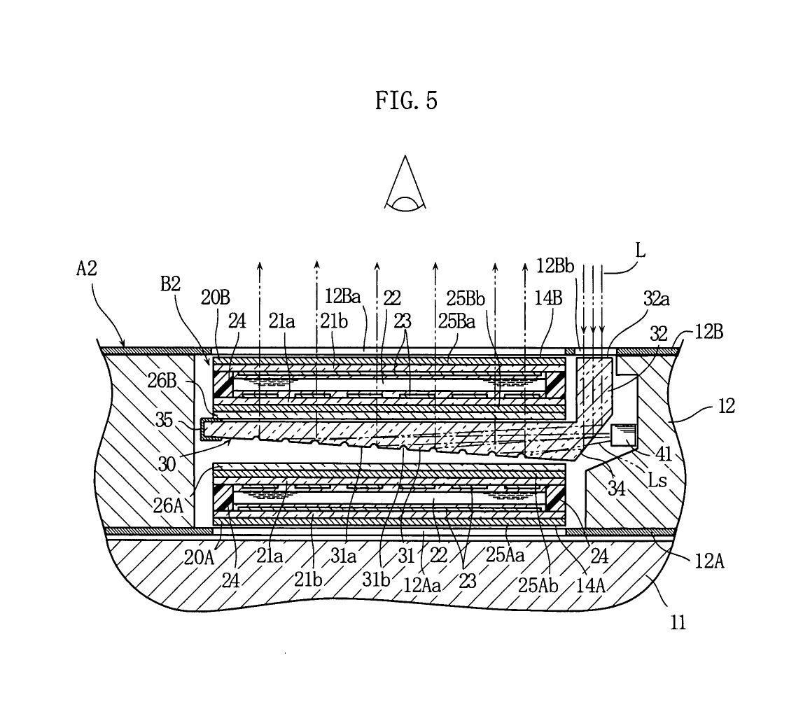

FIG. 5 shows another example of cellular phone and liquid crystal display device according to the present invention.

Similarly to the above-described cellular phone A1, the illustrated cellular phone A2 includes a main body 11 and a lid 12. The lid 12 includes a first display surface 14A at the inner surface thereof and a second display surface 14B at the outer surface thereof. The first and the second display surfaces 14A and 14B are provided by a liquid crystal display device B2 mounted to the lid 12. It is to be noted that FIG. 5 is a sectional view showing a principal portion of the liquid crystal display device B2 mounted to the lid 12. In this figure, the cellular phone A2 in the closed state is illustrated.

Unlike the above-described image display device B1, the image display device B2 includes a light guide plate 30 having a single light incident surface 32a, and an LED 41 as an auxiliary light source.

The light guide plate 30 includes a light emitting portion 31 having an inner surface 31a which is inclined with respect to the first and the second display surfaces 14A and 14B. The inner surface 31a is formed with a plurality of grooves 31b. The light guide plate 30 further includes, at the right end thereof, an inclined surface 34 which is inclined with respect to the light incident surface 32a.

The LED 41 is mounted on the right side of the inclined surface 34 so as to face the inclined surface 34. The LED 41 serves to accessorily illuminate the second liquid crystal display panel 20B. The inclination angle of the inclined surface 34 is so set that the inclined surface 34 can reflect the external light L traveling through the light incident surface 32a located thereabove toward the light emitting portion 31 and also transmit the light Ls emitted from the LED 41 into the light emitting portion 31 while refracting the light. For instance, the LED 41 is turned on when a sensor (not shown) detects that the ambient brightness of the cellular phone A2 has dropped below a predetermined level of brightness or when the user presses a certain button (not shown).

The light emitting portion 31 is provided, at the left end thereof, with a light reflective member 35 which is channel-shaped in section. With this arrangement, the light reaching the light reflective member after traveling through the light emitting portion 31 while repeating reflection is reflected by the light reflective member to return into the light emitting portion 31. By this operation, the amount of light reflected upward by the grooves 31b can be increased.

Similarly to the cellular phone A1, when the second display surface 14B is to be visually recognized in using the cellular phone A2, the second liquid crystal display panel 20B can be illuminated by introducing the external light L through the light incident surface 32a. As noted with respect to the cellular phone A1, for the power saving of a cellular phone, it is preferable that a light source such as an LED is not provided. However, to further enhance the visibility of the second display surface 14B, the brightness of the second display surface 14B can be increased by increasing the amount of light for illuminating the second liquid crystal display panel 20B by the provision of the LED 41 like this embodiment. In this embodiment again, the LED 41 is used for assisting the illumination of the second liquid crystal display panel 20B by utilizing the external light L. Therefore, as compared with the structure of e.g. a conventional cellular phone in which the liquid crystal panel is illuminated by an LED only, the required amount of light is small. Therefore, an energy-saving LED can be used.

Moreover, as compared with e.g. the cellular phone A1, the provision of only the single light emitting surface 32a can reduce the ratio of the light incident surface 32a in the lid 12. Therefore, the area of the display surface 14B can be increased correspondingly, or the lid 12 can be made small.

The image display device and the cellular phone according to the present invention are not limited to the foregoing embodiments. The specific structure of each part of the image display device and cellular phone according to the present invention can be modified in various ways in design.

The structure of the light guide plate is not limited to those of the foregoing embodiments but may be varied as long as it can properly cause the light impinging on the light incident surface to travel through the light emitting portion for emission toward the second liquid crystal display panel and also can properly transmit the light for illuminating the first liquid crystal display panel. The shape and the minute surface structure of the reflective surface and the inner surface of the light emitting portion are not limited to the foregoing embodiments. Further, the light incident surface is not limited to that in the form of a strip. For instance, light incident portions branching from the light emitting portion may be provided so that a plurality of light incident surfaces are arranged in a row. Moreover, the present invention is not limited to the structure including a light guide member in the form of a plate. For instance, a light guide plate in the form of a bar extending in one direction may be employed.

Unlike the foregoing embodiments, in the structure shown in FIG. 3, a half mirror may be provided between the light guide plate 30 and the first liquid crystal display panel 20A so that the reflective surface of the half mirror is positioned on the side of the second liquid crystal display panel 20B.

With such an arrangement, when the second display surface 14B is to be visually recognized, the light emitted from the light emitting portion 31 toward the first liquid crystal display panel 20A can be reflected by the half mirror so that the light can enter the light emitting portion 31 again, which is advantageous for enhancing the visibility of the second display surface 14B. Further, when the first display surface 14A is to be visually recognized, the light impinging on the second display surface 14B and passed through the second liquid crystal display panel 20B can be caused to pass through the half mirror and utilized for illuminating the first liquid crystal display panel 20A.

The usage of the image display device according to the present invention is not limited to a so-called flip phone. The present invention is applicable to various kinds of electronic devices having a double-sided display function such as a PDA (Personal Data Assistance) including display surfaces on opposite surfaces of the lid.

1. A liquid crystal display device comprising:
a first liquid crystal display panel forming a first display surface;
a second liquid crystal display panel forming a second display surface which is oriented in an opposite direction from the first display surface; and
a light guide member including a light emitting portion sandwiched between the first and the second liquid crystal display panels and a light incident portion provided continuously with the light emitting portion and serving to introduce external light into the light emitting portion;
wherein the first liquid crystal display panel is illuminated with external light passed through the second display panel and the light emitting portion of the light guide member; and
wherein the second liquid crystal display panel is illuminated with external light impinged on the light incident portion of the light guide member and guided to the second liquid crystal display panel by the light emitting portion.

2. The liquid crystal display device according to claim 1, wherein the light emitting portion is in a form of a plate.

3. The liquid crystal display device according to claim 1, wherein the light guide member includes a reflective surface for reflecting light entering through the light incident portion toward the light emitting portion.

4. The liquid crystal display device according to claim 1, wherein the light incident portion includes a light incident surface for introducing external light, the light incident surface being exposed in a same direction as the second display surface.

5. The liquid crystal display device according to claim 4, wherein the light incident surface is in a form of a strip and arranged along an edge of the second display surface.

6. The liquid crystal display device according to claim 4, wherein the light incident portion includes a plurality of light incident surfaces arranged to sandwich the second display surface.

7. The liquid crystal display device according to claim 1, wherein each of the first and the second liquid crystal display panels is provided with a pair of polarizers whose polarization directions extend perpendicular to each other; and
wherein, the polarization direction of one of the paired polarizers of the first liquid crystal display panel which is provided on the side of the second liquid crystal display panel corresponds to the polarization direction of one of the paired polarizers of the second liquid crystal display panel which is provided on the side of the first liquid crystal display panel.

8. A cellular phone comprising a main body, and a lid pivotally connected to the main body via a hinge portion;
wherein the liquid crystal display device as set forth in claim 1 is mounted to the lid, and wherein the first and the second display surfaces are provided on an inner surface and an outer surface of the lid, respectively.
